(19) United States
(12) Patent Application Publication
(10) Pub. No.: US 2009/0154976 A1
(43) Pub. Date: Jun. 18, 2009

(54) METHOD AND APPARATUS FOR ENHANCED SHEET HOLD DOWN ON AN IMAGING TRANSPORT

(75) Inventors: Ruddy Castillo, Briarwood, NY (US); Barry P. Mandel, Fairport, NY (US); Gerald A. Domoto, Briarcliff Manor, NY (US)

Correspondence Address: PATENT DOCUMENTATION CENTER;XEROX CORPORATION, 100 CLINTON AVE SOUTH, MAILSTOP: XRX2-020, ROCHESTER, NY, 14644, US

(73) Assignee: XEROX CORPORATION, Norwalk, CT (US)

(21) Appl. No.: 11/955,456

(22) Filed: Dec. 13, 2007

(51) Int. Cl. G03G 15/00

(52) U.S. Cl. 399/406

(57) ABSTRACT

A method of enhancing cut sheet edge hold-down on an imaging transport surface, the method including: (a) moving a cut sheet towards the sheet the imaging transport surface; (b) inducing a desired curl on one of the lead edge and trail edge of the cut sheet before the cut sheet enters the imaging transport surface, inducing a desired curl comprises inducing into the cut sheet a curl tending into the surface of the imaging transport surface.

The present invention relates to image producing machines that include a paper transport system such as solid inkjet printing machines and electrostatographic image producing machines and, more particularly, to such a machine including a method and apparatus for enhanced edge hold-down for sheets being imaged.

One type of electrostatographic reproducing machine is a xerographic copier or printer. In a typical xerographic copier or printer, a photoreceptor surface, for example that of a drum, is generally arranged to move in an endless path through the various processing stations of the xerographic process. As in most xerographic machines, a light image of an original document is projected or scanned onto a uniformly charged surface of a photoreceptor to form an electrostatic latent image thereon. Thereafter, the latent image is developed with an oppositely charged powdered developing material called toner to form a toner image corresponding to the latent image on the photoreceptor surface. When the photoreceptor surface is reusable, the toner image is then electrostatically transferred to a recording medium, such as a sheet of paper, and the surface of the photoreceptor is cleaned and prepared to be used once again for the reproduction of a copy of an original. The sheet of paper with the powdered toner thereon in imagewise configuration is separated from the photoreceptor and moved through a fusing apparatus including a heated fusing member where the toner image thereon is heated and permanently fixed or fused to the sheet of paper.

Given the complexity of Xerox's printing products, it is always advantageous to simplify, merge and/or remove as many of the required processing steps as possible. Ink jet products have the ability to generate an image directly onto a sheet of paper, thus removing the intermediate transfer step currently used in some piezo-electric ink jet systems. To accomplish direct-to-paper printing the paper has to be carefully and accurately registered and held down so that it does not come in contact with the print-heads. Current paper hold-down concepts include; “mechanical grippers”, “electrostatics”, “vacuum hold” and combinations of these systems and devices. Some of the limitations and challenges of the vacuum hold systems are media weight, porosity and pressure loses at the edges. Gripper systems can reliably hold sheet edges down, however these are complex, expensive devices and issues exist if different length media are to be transported. It would be desirable to resolve the vacuum hold-down issues so that media edges could be reliably held down without the use of edge gripper systems. This present disclosure will focus on the enhancement of the vacuum hold method; however, the concept described herein can be applied to electrostatic or other paper holding methods.

This present disclosure describes a technique to improve the “vacuum hold” concept by means of pre-curling the entire paper to be held. An alternate method consists of pre-curling the paper lead edge (LE) and trail edge (TE) only.

There's strong indication that by pre-curling the paper, to a radius that is equal or less than the radius of the vacuum cylinder [or belt surface], the amount of pressure required at the edges is drastically reduced. That is, by pre-shaping the paper to match the curvature of the vacuum cylinder [drum] or to the flatness of the vacuum belt surface, the hold system performance will improve without increasing the suction pressure. Additionally, a de-curling system will be used to remove the paper curl or flatten after printing. Similarly, this concept can be implemented with other paper holding approaches such as with electrostatic systems.

In solid inkjet color image printing, multi-colored images are formed on an intermediate member, such as a drum. Using different colored crayon-like inks that are solid at room temperature but are molten in the printhead, an image-wise pattern is applied to the intermediate member using moving or stationary full width printheads. Special ink formulations have been developed that allow the ink to melt at very precise temperatures, and that solidify very quickly when their temperature drops below such melting temperature. In a solid inkjet printer, the image-wise pattern of solid ink on the intermediate member is then transferred and fused or transfused onto a copy sheet. The fusing or transfusing smoothens out the sheet surface and strengthens the bond between the ink and the sheet. An alternative to the above approach is to form the image directly onto the media, without the use of an intermediate member. This requires the media to be held tightly against an intermediate member so that no portion of the media contacts the printheads during printing. This is difficult to do, especially at the edges of the media. Yet another alternative is to print directly onto the media using UV curable inks. After printing the sheet is then transported through a UV curing station to cure or harden the ink into the sheet.

In accordance with the present disclosure, there has been provided a method of enhancing cut sheet edge hold-down on an imaging transport surface, the method comprising: (a) moving a cut sheet towards the sheet the imaging transport surface; (b) inducing a desired curl on the lead edge of the cut sheet before the cut sheet enters the imaging transport surface, inducing a desired curl comprises inducing into said cut sheet a curl tending into the surface of the imaging transport surface. An apparatus for enhancing cut sheet edge hold-down on an imaging transport surface, comprising: (a) means for moving a cut sheet towards the imaging transport surface; and (b) a sheet curling device positioned upstream of the imaging transport surface relative to movement of said cut sheet for inducing a desired pre-curl in said cut sheet before said cut sheet enters the imaging transport surface.

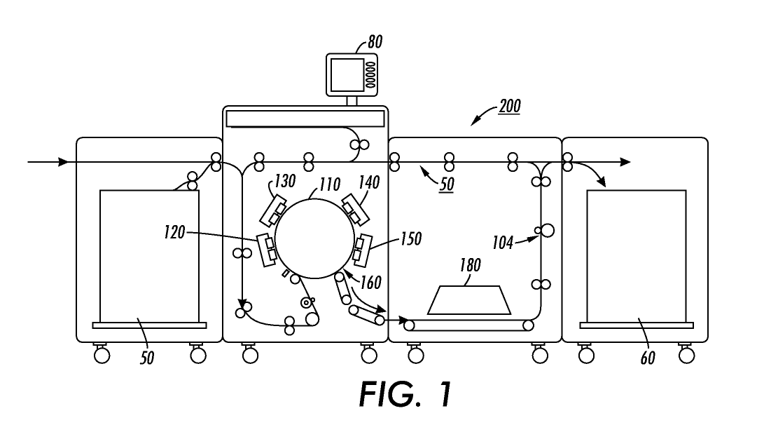

FIG. 1 is a schematic elevational view of an exemplary printing machine including the apparatus in accordance with the present disclosure.

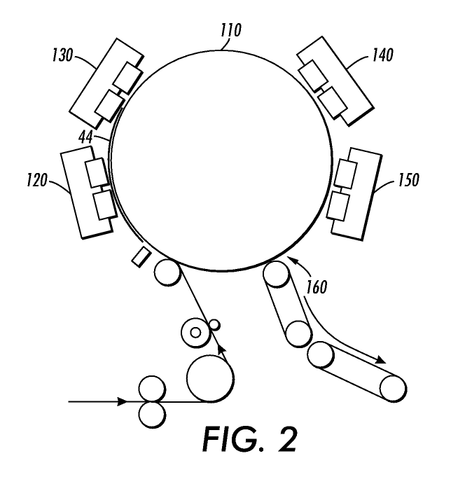

FIG. 2 is an enlarged view of the process station of the printing machine.

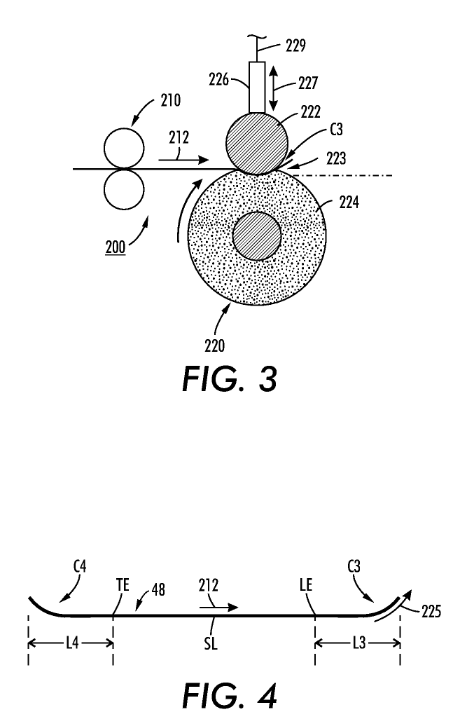

FIG. 3 is an exemplary decurler device employed with the present disclosure.

FIG. 4 is a schematic of a cut sheet pre-curled in accordance with the present disclosure.

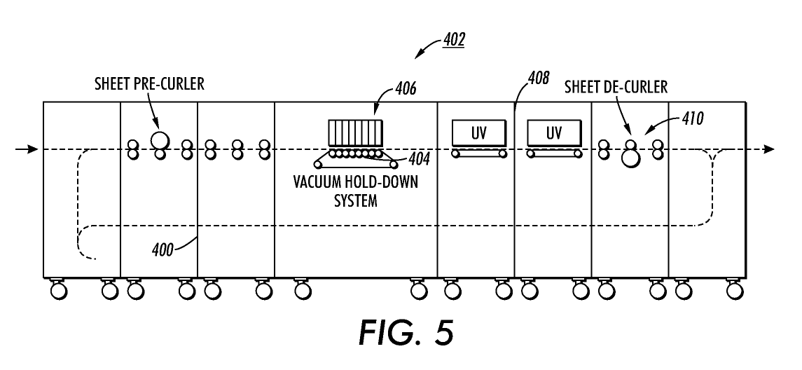

FIG. 5 is a schematic elevational view of a belt type printing machine.

As illustrated in FIG. 1, the image producing machine 200 includes an imaging member 110 that is shown in the form of a drum, but can equally be in the form of a supported endless belt. The imaging member 110 has an imaging surface, also referred to herein as an ink receiving surface, which receives molten solid ink ejected from printheads 120, 130, 140, and 150 to form images. The receiving surface is movable with respect to the printheads 120, 130, 140, and 150 along a receiving surface path as shown by arrows. As illustrated the receiving surface is the cut sheet or substrate. The receiving surface path can be the path taken by the substrate during the image forming process which can be referred to as the substrate path, also referred to as the substrate handling path, also referred to as the paper path. Imaging transport member 110 which receives the cut sheet includes a blower (not shown) for generating a vacuum that causes the cut sheet to be attracted and conform to the surface of the imaging transport member 110. In an alternative embodiment cylinder [drum] or belt can employ a charging device (not shown) to generate by an electrostatic charge on the surface of the imaging transport member 110 to cause the cut sheet to be attracted to the surface of the imaging transport member 110.

In the examples provided, the image producing machine 200 is a multicolor image producing machine having an ink delivery system which includes four sources holding four different colors CYMK (cyan, yellow, magenta, black) of inks. The ink delivery system is suitable for supplying the ink in liquid form to a plurality of printheads 120, 130, 140, and 150 which eject the ink onto the sheet held against the receiving surface 14 when forming an image.

The image producing machine 200 also includes a substrate supply and handling system. The substrate supply and handling system can include a plurality of substrate supply source 50 of which supply source 50, for example, is a high capacity paper supply or feeder for storing and supplying image receiving substrates in the form of cut sheets. The substrate supply and handling system can include a fusing or fixing device 180. Further, the print media sources may be loaded with print media of different types. Each document feeder tray may include print media having different attributes such as roughness, coats, weights and the like.

The image producing machine 200 also includes an ink delivery system 100 (not shown) that has a source of at least one color ink.

Operation and control of the various subsystems, components and functions of the image producing machine 200 are performed with the aid of a controller 80. The controller 80 can be a self-contained, dedicated computer having a central processor unit (CPU), electronic storage, and a display or user interface (UI). The controller 80 can include sensor input and control means as well as a pixel placement and control means. The CPU reads, captures, prepares and manages the image data flow between image input sources such as the scanning system, or an online or a work station connection, and the printheads. As such, the controller 80 is the main multi-tasking processor for operating and controlling machine subsystems and functions, including the operation of the ink delivery system. Decisions about when to fill each printhead would be made by the controller 80 based on input from ink level sensors located in the individual printhead reservoirs.

In operation, image data for an image to be produced is sent to the controller 80 from, for example, the scanning system or via a work station network connection for processing and output to the printheads. Additionally, the controller 80 determines and/or accepts related subsystem and component controls, for example from operator inputs via the user interface 86, and accordingly executes such controls. As a result, appropriate color inks are delivered to the printheads 30. The cut sheet 48 (not labeled) is removed from imaging transport 110 by stripper 160. Then cut sheet 48 (not labeled) moves to UV cure station 180.

Now focusing on aspects of the present disclosure, cut sheet 48 enters sheet curling device 220 which includes means such as rollers 222, 224 for inducing into the cut sheet 48 the curl C3 tending as shown by the arrow in FIG. 4. The curl C3 curled as such will cause the very edge of the lead edge LE to be pointing toward the surface on imaging transport 110. The curling device 220 used in the novel manner here in a pre-marking location can comprise any suitable curling/de-curling assembly as are known in the art, and for example can comprise a standard roll decurler as shown including a hard roller 222 and soft roller 224 forming a curling nip 223. In this application, the hard roller 222 is located to the same side of the sheet 48 as the imaging transport member 110. The soft roller 224 is located on the opposite side as shown. In operation, with the lead edge LE of the sheet 48 entering the curling nip 223, moving the hard roller 222 into the soft roller 224 will start to induce the away curl C3 into the sheet 48 starting from such lead edge LE. The sheet curling device 220 also includes control means 226 connected at 229 to the machine control 29 that can be turned on and off, and/or moved in and out as shown by the arrows 227, for inducing the curl C3 starting from a lead edge LE of the cut sheet 48, and extending only a relatively short distance L3 back into the cut sheet 48. The relatively short distance L3 for example can be a range of approximately 4 to 40 mm in length. This is controlled by engaging and disengaging the curling rollers 222, 224 only momentarily. In a similarly manner the trailing edge of the sheet is curled by curling device 220 inducing the curl C4 to a relatively short distance L4 for example can be a range of approximately 4 to 40 mm in length. As mentioned above, other curling/de-curling technologies could be used to perform this function. For example, if the media was stopped during the time that the lead-edge pre-curling operation was taking place, the large diameter soft roller could be replaced by a simple block or pad of soft material.

Preferably, the curl C3 and C4 has a radius that is equal or less than the radius of the vacuum cylinder [or belt surface]. Applicants have found that in case of a vacuum cylinder that the amount of pressure required at the edges is drastically reduced. That is, by pre-shaping the paper to match the curvature of the vacuum cylinder [drum] or to the flatness of the vacuum belt surface, the hold system performance will improve without increasing the suction pressure.

A post fusing nip de-curling device 104 may be provided for selectively removing any detected undesirable curl from the sheet as shown in FIG. 1. Similarly, de-curling device 104 can comprise a soft central roller, a pair of hard rollers that form two de-curling nips for removing opposite direction curls from sheet 48.

The above descriptions have focused on a drum based architecture, however a similar approach could also be employed when marking directly onto sheets being transported using a relatively flat belt system as shown in FIG. 5. Paper is transported on belt system 400 to sheet pre-curler 402 to vacuum hold-down system 404 where printheads 406 forms an image on the sheet. Thereafter, ink is curled by UV system 408 and sheet is de-curled by de-curler 410. Note that in this case, the sheet lead and trail edges would be pre-curled only to a level required to ensure that they were flat or slightly down-curled. Since media can arrive at a print station with a range of curl levels, depending on humidity and other factors, it is still important to ensure that the sheet edges do not curl towards the print heads.

It should also be noted that amount of curl induced onto the sheet lead and/or trail edges can be controlled by measuring the curl on the sheet using optical sensors or other means.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method of enhancing cut sheet edge hold-down on an imaging transport surface, the method comprising:
(a) moving a cut sheet towards the imaging transport surface;
(b) inducing a desired curl on one of the lead edge and the trail edge of the cut sheet before the cut sheet enters the imaging transport surface, inducing a desired curl comprises inducing into said cut sheet a curl tending into the surface of the imaging transport surface.

2. The method of claim 1, further comprising inducing a desired curl on both the leading edge and trailing edge of the cut sheet before the trailing edge of the cut sheet enters the imaging transport surface.

3. The method of claim 1, further comprising attracting portions of said cut sheet to the said imaging transport surface with a hold down device.

4. The method of claim 3, wherein attracting portions of said cut sheet comprises generating an electrostatic force to hold down said sheet.

5. The method of claim 3, wherein attracting portions of said cut sheet comprises generating a vacuum force to hold down said sheet.

6. The method of claim 1, wherein inducing a desired curl comprises inducing the curl starting from a lead edge of said cut sheet and extending a relatively short distance only into said cut sheet.

7. The method of claim 6, inducing a desired curl comprises inducing the curl in a direction into the imaging transport starting from a lead edge of said cut sheet and only over a partial distance of approximately 4 to 40 mm into said cut sheet.

8. The method of claim 1, wherein inducing a desired curl comprises controlling the amount of desired curl based upon the media attributes of said cut sheet.

9. The method of claim 1, wherein inducing the desired curl comprises controlling the amount of curl imparted on the sheet based on a measurement of curl in the sheet.

10. The method of claim 1, wherein inducing a desired curl comprises inducing curl only on the lead edge and trailing edge of said cut sheet.

11. The method of claim 1, further comprising de-curling said cut sheet to remove said desired pre-curl in said cut sheet after said cut sheet is imaged.

12. An apparatus for enhancing cut sheet edge hold-down on an imaging transport surface, comprising:
(a) means for moving a cut sheet towards the imaging transport surface; and
(b) a sheet curling device positioned upstream of the imaging transport surface relative to movement of said cut sheet for inducing a desired pre-curl in one of the lead edge and trail edge of said cut sheet before said cut sheet enters the imaging transport surface.

13. The apparatus of claim 1, further comprising a sheet de- curling device positioned downstream of the imaging transport surface relative to movement of said cut sheet for removing said desired pre-curl in said cut sheet.

14. The apparatus of claim 12, further comprising means for attracting portions of said cut sheet to the said imaging transport surface.

15. The apparatus of claim 14, wherein attracting means comprises means for generating an electrostatic force on the imaging transport surface to hold down said cut sheet.

16. The apparatus of claim 14, wherein attracting means comprises means for generating a vacuum force on the imaging transport surface to hold down said cut sheet.

17. The apparatus of claim 12, wherein sheet curling device induces curl only on the lead edge and trailing edge of said cut sheet.

18. The apparatus of claim 12, wherein said sheet curling device includes control means for inducing said curl starting from a lead edge of said cut sheet and extending a relatively short distance only into said cut sheet.

19. The apparatus of claim 18, wherein said relatively short distance is approximately a range of 4 to 40 mm in length 10.
